(19) United States
(12) Patent Application Publication
(10) Pub. No.: US 2026/0280296 A1
(43) Pub. Date: Sep. 17, 2026

(54) METHOD FOR BALANCING LOADS ON A POLYPHASE ELECTRICAL NETWORK, BALANCING DEVICE AND CORRESPONDING COMPUTER PROGRAM

(71) Applicant: SAGEMCOM ENERGY & TELECOM SAS, Bois-Colombes (FR)

(72) Inventor: Christophe GRINCOURT, Bois-Colombes (FR)

(73) Assignee: SAGEMCOM ENERGY & TELECOM SAS, Bois-Colombes (FR)

(21) Appl. No.: 19/566,760

(22) Filed: Mar. 13, 2026

(30) Foreign Application Priority Data
Mar. 14, 2025 (FR) 2502587

(51) Int. Cl. H02J 3/26; H02J 3/14; H02J 13/12; H02J 13/34; H02J 105/50

(52) U.S. Cl. CPC H02J 3/26; H02J 3/14; H02J 13/12; H02J 13/34; H02J 2105/51

(57) ABSTRACT

A method is proposed here for balancing the loads in a polyphase electrical network each phase of which supplies electrical energy to at least one connection point of an electrical installation of a subscriber. The method is implemented in a balancing device connected to said plurality of phases and includes a plurality of electromechanical relays, each electromechanical relay being adapted to connect a phase in said plurality of phases to an output phase of said connection point. The method includes, after reception of a phase connection change request, performing a phase connection change step to switch from a connection, via a first electromechanical relay, to a first phase to which said output phase is initially connected, to a connection, via a second electromechanical relay, of said output phase to a second phase of said electrical network.

### TECHNICAL FIELD

The present disclosure relates to the management of polyphase electricity distribution networks. More particularly, the present disclosure relates to the balancing of the loads on such polyphase electricity distribution networks.

### PRIOR ART

Electricity distribution networks (also hereinafter referred to as “electrical networks” or “polyphase electrical networks”) are mainly polyphase. More particularly, electricity distribution networks are in general three-phase. In this case, the electricity is distributed via three distinct phase conductors (also hereinafter referred to as “phases”). This allows more effective use of energy by distributing the load over several phase conductors.

The term “load” refers to the quantity of electricity demanded by users (also hereinafter referred to as “subscribers”) at a given moment. It is directly related to the phase of the polyphase electricity distribution network since the load may be distributed over all the phases or concentrated on a single phase. A balanced distribution of the load between the phases optimises the operation of the electricity distribution network and prevents overloads on a specific phase. Thus, balancing the loads between the various phases is essential for electricity suppliers.

When a subscriber is installed, the phase of the network to which they are connected is selected definitively. However, consumption may vary from one subscriber to another and fluctuate over time. A subscriber may add high-consumption appliances (e.g. swimming pool, jacuzzi, electric car, etc). They may also install electricity generators (e.g. solar panels, wind turbines, etc). These additions create an imbalance of the loads that cannot easily be compensated for.

A load imbalance may cause voltage fluctuations. This disturbs the stability of the distribution network and may cause faults. An imbalance also causes overheating of equipment, especially three-phase motors. Overheating may degrade the insulation of the cables and equipment. This increases the risk of short-circuits and failures. Furthermore, a load imbalance reduces energy efficiency and may damage equipment. In large-scale systems, a persistent imbalance may cause electrical faults.

The prior art does not propose satisfactory solutions for solving this problem. There is at the present time no effective solution for correctly balancing the distribution of energy between the phases of an electricity distribution network.

The situation can therefore be improved. It is in particular desirable to provide a solution for distributing the load between the various phases of the distribution network in an optimised manner, thus ensuring more balanced use of energy, a reduction in risks of overload and an improvement in the global energy performance of the distribution network.

### DISCLOSURE OF THE INVENTION

A method is proposed here for balancing the loads in an electrical network comprising a plurality of phases, each phase supplying electrical energy to at least one connection point adapted to connect an electrical installation of a subscriber to said electrical network. The method is implemented in a balancing device connected to said plurality of phases, said balancing device comprising a plurality of electromechanical relays, each electromechanical relay being adapted to connect a phase in said plurality of phases to an output phase of said connection point, said output phase being intended to supply electrical energy to the electrical installation of the subscriber. The method comprises, after reception, via a communication module, of a phase connection change request, commanding a phase connection change step to switch from a connection, via a first electromechanical relay, to a first phase to which said output phase is initially connected, to a connection, via a second electromechanical relay, of said output phase to a second phase of said electrical network.

Thus, in the case of imbalance of the loads in the electrical network, it is possible to change the input phase to which a connection point of an electrical installation of a subscriber is connected to rebalance the loads.

In particular, said phase connection change step comprises:
commanding opening of all the electromechanical relays of said balancing device,
obtaining a first measurement of a voltage downstream of the electromechanical relays, and then, after a predetermined period, obtaining a second measurement of a voltage downstream of the electromechanical relays,
obtaining a third measurement of a voltage downstream of the electromechanical relays at the end of the predetermined period, when said first measurement is different from 0 and said second measurement is equal to 0,
commanding closure of said second electromechanical relay if: (i) said first measurement is equal to 0 and said second measurement is equal to 0, or (ii) said first measurement is different from 0, said second measurement is equal to 0 and said third measurement is equal to 0.

Advantageously, this input phase connection change is protected by monitoring the voltage downstream of the electromechanical relays. These relays connect one of the input phases of the network to the output phase of the connection point supplying the electrical installation of the subscriber.

Furthermore, said phase connection change step furthermore comprises: commanding closure of said first electromechanical relay if: (i) said first measurement is different from 0 and said second measurement is different from 0, or (ii) said first measurement is different from 0, said second measurement is different from 0 and said third measurement is different from 0.

According to one embodiment, said predetermined period is 20 ms when said electrical network has a frequency of 50 Hz or 16.7 ms when said electrical network has a frequency of 60 Hz or one second, preferentially 20 ms when said electrical network has a frequency of 50 Hz or 16.7 when said electrical network has a frequency of 60 Hz.

Advantageously, the voltage measurements are made at the period of the signal of the electrical network in question (50 Hz or 60 Hz) in order to limit the electricity cutoff time.

According to one embodiment, commanding closure of said first electromechanical relay furthermore comprises: transmitting an alert message to an information system of an electricity supplier.

A device is also proposed for balancing the loads in an electrical network comprising a plurality of phases, each phase supplying electrical energy to at least one connection point adapted to connect an electrical installation of a subscriber to said electrical network. The balancing device is connected to said plurality of phases. The balancing device comprises a plurality of electromechanical relays, each electromechanical relay being adapted to connect a phase in said plurality of phases to an output phase of said connection point, said output phase being intended to supply electrical energy to the electrical installation of the subscriber. The balancing device comprises electronic circuitry configured to: after reception, via a communication module, of a phase connection change request, command a phase connection change step to switch from a connection, via a first electromechanical relay, to a first phase to which said output phase is initially connected, to a connection, via a second electromechanical relay, of said output phase to a second phase of said electrical network.

An electricity meter comprising a balancing device as described previously is also proposed here.

A computer program product is also proposed, comprising instructions causing the execution, by a processor, of the above-mentioned method according to any one of the embodiments thereof, when said instructions are read and executed by the processor.

A storage medium is also proposed, storing such instructions causing the execution, by the processor, of the above-mentioned method according to any one of the embodiments thereof, when said instructions are read from the storage medium and executed by the processor.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically an example of an environment for implementing the method for balancing loads in a polyphase electrical network, according to one embodiment;

FIG. 2 illustrates schematically an example of a hardware platform for implementing, in the form of electronic circuitry, a device for balancing the loads in a polyphase electrical network, according to one embodiment;

FIG. 3A, FIG. 3B and FIG. 3C illustrate schematically various examples of hardware architecture of a device for balancing loads in a polyphase electrical network, according to particular embodiments;

FIG. 4 illustrates schematically the steps of the method for balancing loads in a polyphase electrical network, according to one embodiment.

### DETAILED DISCLOSURE OF EMBODIMENTS

The general principle of the present disclosure consists in changing, at any moment, according to the load on each of the phases of the electrical network, the phase or phases to which a single-phase or polyphase connection point of an electrical installation of a subscriber is or are initially connected. More particularly, the present disclosure relates to a method for switching from a connection to one or more phases to which the connection point is initially connected to a connection to one or more new phases, according to the load on each of the phases of the electrical network.

As mentioned previously, the choice of the phase of the electrical network to which the connection point of the subscriber is connected is made definitively, at the time of the connection of the electrical installation of the subscriber to the electrical network. It is therefore not possible to balance the loads on the electrical network by changing the choice of the phase to which the connection point of the electrical installation of the subscriber is connected.

The term “single-phase or polyphase connection point” (also referred to as “connection point”) refers here to a connection point of the electrical installation of the subscriber that is connected to one or more so-called “input” phases of the electricity distribution network. This connection point is either single-phase (i.e. a single “outgoing” phase supplies the electrical installation of the subscriber), or polyphase (i.e. several “outgoing” phases supply the electrical installation of the subscriber). Hereinafter, the term “input phase” refers to a phase of the electrical network arriving at the connection point, and the term “output phase” refers to a phase starting from the connection point and supplying electricity to the installation of the subscriber.

Thus the connection point constitutes an interface between the electrical installation of the subscriber and the electrical network supplying electricity to the domestic or industrial installation of a subscriber. In general, this connection point is equipped with an electricity meter, for measuring the electricity supplied to the subscriber.

The objective is therefore to be able to change the phase or phases of the electrical network to which the output phase or phases of the connection point of the electrical installation of the subscriber are initially connected, according to a load level of each phase of the electrical network, in order to be able to optimise the balancing of the loads of the phases of the electrical network when necessary.

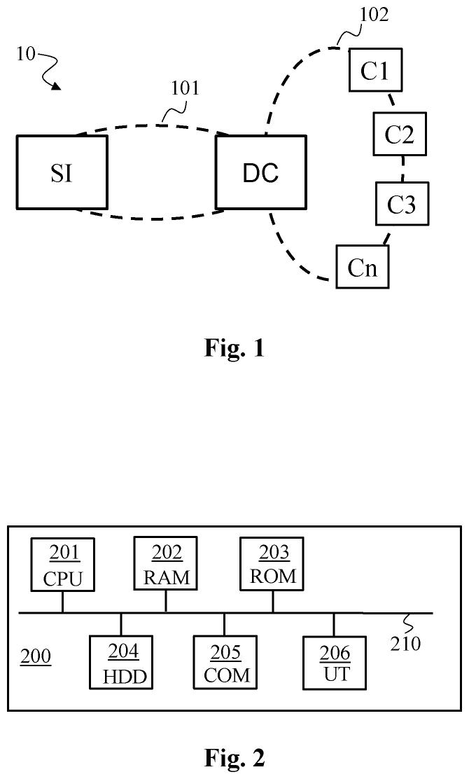

FIG. 1 thus illustrates schematically an example of an environment for implementing the method for balancing loads in a polyphase electrical network, according to one embodiment.

In this non-limitative example, a network for conveying electricity conveys the electricity from the production stations to the end users (or subscribers), such as homes or businesses. Such an electricity-conveying network comprises in particular a transport network (which transports the electricity over long distances at high voltage) and the distribution network 103 (which brings the electricity at lower voltage levels for the consumer in homes or businesses). The electricity distribution network 103 comprises two types of network: a medium-voltage network 1031 comprising medium-voltage lines (voltage between 15 kV and 30 kV) and a low-voltage network 1032 comprising low-voltage lines (voltage of 230 V or 400 V). An MV/LV transformer (or MV/LV transformer station) included in a substation 102 provides the connection between the medium-voltage lines and the low-voltage lines. In particular, the MV/LV transformer reduces the medium voltage to a lower voltage (220 V to 400 V) to make it compatible with domestic and industrial use. Thus the low-voltage lines of the low-voltage network 1032 serve to supply electricity to the electrical installations of the subscribers from the MV/LV transformer to homes and businesses.

As mentioned above, the electricity distribution network 103 is in general polyphase in order to guarantee balanced and effective distribution of electrical energy. More particularly, high-voltage 1031 and low-voltage 1032 electrical networks are in general composed of three conductors of distinct phases L1, L2, L3, respectively L1′, L2′, L3′ (also hereinafter referred to as “phase”) and, where applicable, a neutral phase conductor (also hereinafter referred to as “neutral”). The electrical network 103 is then said to be “three-phase”. It should be noted that other types of polyphase electrical network exist, such as electrical networks comprising only two phase conductors (a so-called “two-phase” electrical network).

It should be noted that hereinafter the electrical network considered is the low-voltage electrical network 1032 and the input phases are the phases denoted L1′, L2′, L3′ starting from the MV/LV transformer of the substation 102.

The electrical network 1032 conveys the electricity as far as the connection point (single-phase or polyphase) of the subscriber in their home or business, where an electricity meter measures the electrical energy consumption. These electricity meters are sometimes equipped with communication interfaces allowing the remote collection of consumption data (e.g. smart electricity meters). For example, electricity meters may incorporate a communication interface enabling them to communicate via a network of the powerline (or PL) network type, facilitating the transmission of data, at regular intervals or according to specific requirements, to an information system of an electricity supplier or a data concentrator, for centralised processing thereof. In fact the information systems or data concentrators collect and centralise the consumption data coming from various electricity meters equipping various connection points. The data concentrators distribute the collection load and act as relays between the electricity meters and the information systems. They play a crucial role in energy management, allowing real-time monitoring of consumptions and rapid detection of any abnormalities or imbalances. The data collected are next transmitted to the electricity supplier and processed for optimum management of the whole of the electrical network, thus facilitating maintenance and optimisation of this network.

According to the (non-limitative) example in FIG. 1, a system 10 for managing electricity meters comprises at least one information system SI and, where applicable, at least one data concentrator DC. The information system SI and the data concentrator DC are configured to communicate together via a first communication network 101. For example, the first communication network 101 is a cellular communication network complying with the 2G to 5G, LTE-M or NB-IoT (“Narrow Band Internet-of-Things”) specifications.

The data concentrator or concentrators DC are configured to communicate, furthermore, with a set of electricity meters C1 to Cn via a second communication network 102. The second communication network 102 is, for example, a PLC network complying with the G3-PLC or PRIME, or G3-Hybrid or PRIME-Hybrid specifications

In a variant, the information system SI and the meters C1, C2, C3, Cn are configured to communicate together directly (i.e. without passing through a data concentrator DC) via a communication network, for example complying with the 2G to 5G, LTE-M, or NB-IoT specifications.

The electricity meters C1 to Cn are installed at the connection point at the subscriber and are configured to measure consumption, by this subscriber, of an electricity resource that is distributed to equipment via an electrical installation of the subscriber. The electricity meters C1 to Cn are furthermore configured to transmit to the information system SI directly or, where applicable, via the data concentrator DC, consumption data representing the consumption of the subscriber over a predetermined period. Example, the electricity meters C1 to Cn transmit daily consumption data every day.

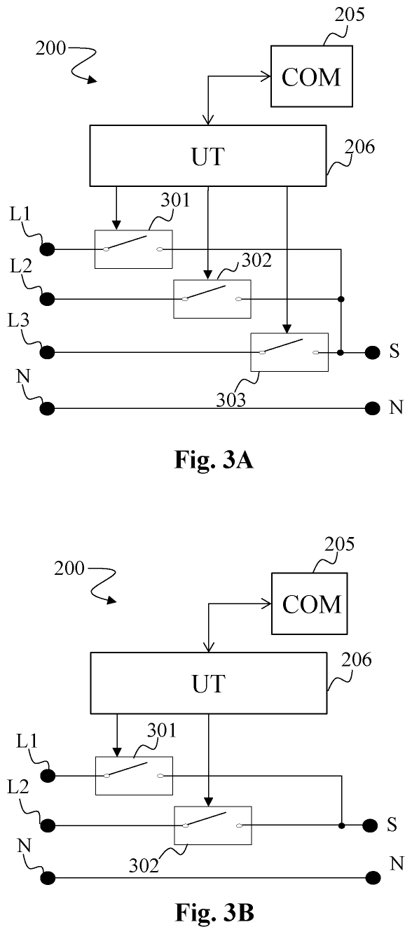

FIG. 2 illustrates schematically an example of a hardware platform for implementing, in the form of electronic circuitry, the device for balancing the loads in a polyphase electrical network, according to one embodiment;

The hardware platform comprises, connected by a communication bus 210: a processor or CPU (“Central Processing Unit”) 201; a random access memory RAM 202; a memory 203, for example of the ROM (“read-only memory”) or EEPROM (“Electrically Erasable Programmable ROM”) type, such as a flash memory; a storage unit, such as a hard disk drive HDD 204, or a storage medium reader, such as an SD (“Secure Digital”) card reader; and at least one communication module COM 205.

According to one embodiment, the balancing device 200 furthermore comprises a processing module UT 206. The processing module UT 206 and the communication module COM 202 are configured to communicate together. Furthermore, the processing module UT 206 is configured to control the opening and closing of a plurality of electromechanical relays (hereinafter also referred to as “relays”) of the balancing device 200. The processing module UT 206 can thus control the closing or opening of one or more relays to connect/disconnect one or more input phases of the electrical network to/from one or more output phases of the connection point supplying electricity to the electrical installation of the subscriber. The processing module UT 206 is furthermore configured to obtain measurements of the voltage downstream of the relays of the balancing device 200 and to analyse these measurements.

The communication module COM 205 is configured to enable the balancing device 200 to interact with the information system SI or the data concentrator DC. In particular, the communication module COM 205 enables the balancing device 200 to receive, coming from the information system SI directly, or via the data concentrator DC, instructions to change connection to the electrical network. For example, the communication module COM 205 may be a PLC, radio-frequency, cellular, etc communication port.

The processor 201 is capable of executing instructions that form a computer program and are loaded in the random access memory 202 from the read-only memory 203, from an external memory, from a storage medium (such as an SD card), or from a communication network. When the hardware platform is powered up, the processor 201 is capable of reading the aforementioned instructions from the random access memory 202 and executing them. When they are read from the random access memory 202 or a storage medium and executed by the processor 201, these instructions (which form a computer program) cause the execution, by the processor 201, of all or some of the steps or methods or more broadly the operating sequences described in the present disclosure.

All or some of the steps and operations described here can thus be implemented in software form by executing a set of instructions by a programmable machine, for example a processor of the DSP (“digital signal processor”) type or a microcontroller, or be implemented in hardware form by a machine or a dedicated electronic component (“chip”) or a set of dedicated electronic components (“chipset”), for example an FPGA (“field-programmable gate array”) or ASIC (“application-specific integrated circuit”) component. In general terms, the balancing device 200 comprises electronic circuitry adapted and configured to implement all or some of the operations, methods and steps described below.

It should be noted that the term “module” may correspond both to a software component and to a hardware component or a set of hardware and software components, a software component itself corresponding to one or more computer programs or sub-programs or more generally to any elements of a program able to fulfil a function or a set of functions.

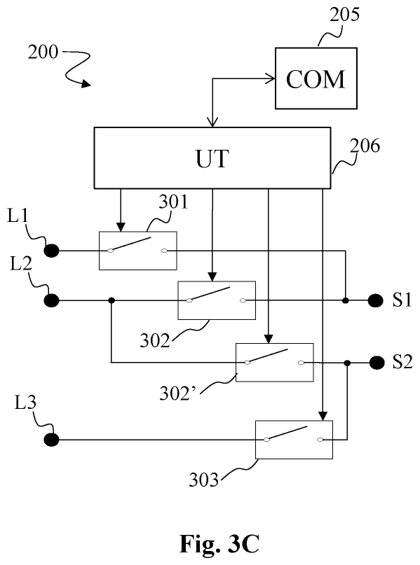

FIG. 3A, FIG. 3B and FIG. 3C illustrate schematically various examples of hardware architecture of a device for balancing loads in a polyphase electrical network, according to particular embodiments.

According to one embodiment, the balancing device 200 is connected (or coupled) to all the phases of a polyphase electrical network. According to an example illustrated in FIG. 3A, this polyphase electrical network is a three-phase electrical network comprising three input phases L1, L2 and L3 and a neutral N. In another example illustrated in FIG. 3B, this polyphase electrical network is a two-phase electrical network comprising only two input phases L1 and L2 and a neutral N.

The balancing device 200 furthermore comprises several electromechanical relays (hereinafter “relays”), denoted 301, 302, 302′, 303. Each relay 301, 302, 302′, 303 is connected to an input phase L1, L2, L3 of the polyphase electrical network. In the example in relation to FIG. 3A, the balancing device 200 comprises three relays 301, 302 and 303 each connected to an input phase L1, L2, L3 of the three-phase electrical network. According to the example in relation to FIG. 3B, the balancing device 200 comprises two relays 301 and 302 each connected to an input phase L1, or L2 of the two-phase electrical network.

The term “electromechanical relay” here refers to an electromechanical device able to make it possible to open or close an electrical circuit in response to a control signal supplied by a processing module UT 206. This processing module UT 206 therefore generates an instruction to close or open the relay, thus activating its mechanism for controlling the passage of the current in the circuit.

Thus, after reception of an opening or closing control signal coming from the processing module UT 206, the relays 301, 302, 302′, 303 are able to:
connect one or more of the input phases L1, L2, L3 to one or more output phases of the connection point, when they are in a “closed” configuration,
to disconnect one or more phases L1, L2, L3 from the output phases of the connection point, when they are in an “open” configuration,

According to one embodiment (see for example FIG. 3A and FIG. 3B), the balancing device 200 is configured to connect to an input phase a single output phase S of a single-phase connection point of a subscriber. As mentioned previously, this output phase S therefore make it possible then to supply electrical energy to the electrical installation of the subscriber. Thus, in the examples illustrated in FIG. 3A and FIG. 3B, a single relay 301, 302 or 303 must be closed to connect one of the input phases L1, L2 or L3 to the output phase S of the connection point. It should be noted that the other relays 301, 302 or 303 are open to avoid another input phase L1, L2 or L3 being connected to the output phase S at the same time as the one already connected. This is because, in a polyphase network, it is essential to connect only one phase of the polyphase electrical network to the single-phase connection point of the installation of the subscriber in order to maintain a suitable voltage of 230 V. If two phases (e.g. the phases L1 and L2) are connected (i.e. relay 301 and 302 closed) at the same time, this creates a risk of overvoltage and damage to equipment, or even danger for the safety of the subscriber.

According to a particular embodiment, for example as illustrated in FIG. 3C, the balancing device 200 is configured to connect to several input phases to several output phases S1, S2 of a polyphase connection point of a subscriber. In this case, each output phase S1, S2 can be connected to an input phase L1, L2 or L3. It should be noted that a single input phase of the electrical network can be connected via various relays to several distinct output phases. More particularly, the balancing device 200 is configured to connect two output phases S1 and S2 of a two-phase connection point of a subscriber to two input phases of a polyphase electrical network. In this example, the balancing device 200 is connected to a three-phase electrical network comprising the three phases L1, L2 and L3, but without a neutral. The first output phase S1 can be connected to an input phase of the three-phase electrical network selected from a set of input phases comprising a first input phase L1 and a second input phase L2. The second output phase S2 can be connected to an input phase of the three-phase electrical network selected from a set of input phases comprising a third input phase L3 and the second input phase L2.

According to this example, two relays must be closed to connect an input phase—output phase voltage. For this purpose, in order to connect each output phase S1 and S2 to an input phase selected from a predetermined set of input phases, one of the relays 301, 302, 302′, 303 must be closed. For example, to connect the first output phase S1 to the first input phase L1, the relay 301 to which the first input phase L1 is connected is closed, whereas the relay 302 to which the second input phase L2 is connected is opened. To connect the second output phase S2 to the third input phase L3, the relay 303 which the third input phase L3 is connected is closed, whereas the relay 302′ to which the second input phase L2 is connected is opened.

Thus, in the case for example of a dwelling wired in three-phase, it is possible to connect each of the three input phases L1, L2 and L3 of the electrical network to each of the three output phases of a three-phase connection point of the dwelling. For this purpose, it is necessary to use either a balancing device 200 comprising nine relays (i.e. three relays for each input phase of the three-phase electrical network), or three balancing devices 200, one balancing device 200 for each input phase L1, L2, L3 of the three-phase electrical network.

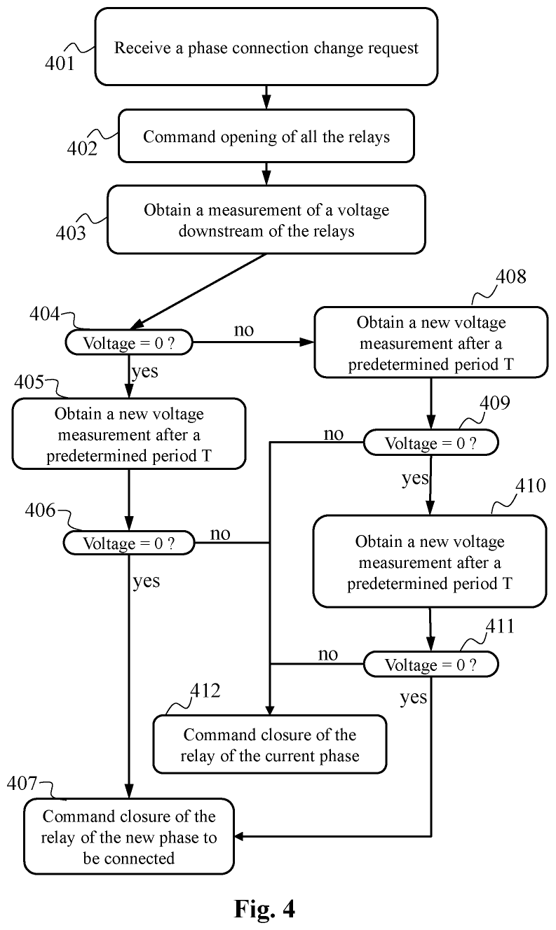

FIG. 4 illustrates schematically the steps of the method for balancing loads in a polyphase electrical network, according to one embodiment. All or part of the balancing method is used (or implemented) in the balancing device 200 as described previously, according to one or other or a combination of the embodiments described.

During a step 401, the balancing device 200 receives, via its communication module COM 205, coming from the information system SI directly or via the data concentrator DC, an instruction to change connection to the electrical network. This instruction is, for example, transmitted to the balancing device 200 in the form of a message comprising a request to change phase connection.

For this purpose, the electrical meters C1 to Cn measure in real time a voltage of each of the input phases L1, L2, L3 of the electrical network upstream of the relays of the balancing device 200. In a variant, the electrical meters C1 to Cn obtain in real time a voltage of each of the input phases L1, L2, L3 of the electrical network upstream of the relays of the balancing device 200. This is the case, for example, when the balancing device 200 is configured to measure in real time a voltage of each of the input phases L1, L2, L3 of the electrical network upstream of the relays.

This voltage measurement is transmitted by the electricity meters C1 to Cn directly to the information system SI, or via the data concentrator DC. The electricity supplier therefore has in real time information relating to the consumption at each point of connection to the electrical network. Thus, the electricity supplier is capable of detecting an imbalance in the loads on the electrical network. The electricity supplier can therefore remotely manage the switching of one or more first phases to which the connection point of the subscriber is initially connected, to one or more second phases in order to balance the loads on the electrical network.

Thus, if the imbalance of the loads exceeds a predetermined threshold, then, in order to rebalance the loads on the electrical network, the information system SI sends to the balancing device 200 a request to change phase connection in order to change the input phase to which an output phase of a connection point is initially connected.

According to one embodiment, this request to change phase connection comprises in particular information representing an identity of a new input phase (e.g. identifier of the input phase) to which an output phase S, S1, S2 is to be connected. Thus, the balancing device 200 can change the current connection of the output phase S, S1, S2 by changing from a connection to an input phase L1, L2, L3 to which the output phase S, S1, S2 is initially connected, to a new input phase L1, L2, L3 identified in the phase connection change request.

The communication module COM 205 next transmits this phase connection change request to the processing module UT 206. The processing module UT 206 then commands the change of input phase to which the output phase S, S1, S2 is connected at time t (i.e. at the moment of reception of the phase connection change request).

For this purpose, during a step 402, the processing module UT 206 commands the opening of all the electromechanical relays 301, 302, 302′, 303 of the balancing device 200. For this purpose, an opening command signal is sent by the processing module UT 206 to all the relays 301, 302, 302′, 303 of the balancing device 200.

In order to guarantee electrical safety, a check to verify that all the relays 301, 302, 302′, 303 are indeed open is necessary before re-closing the new relay or relays 301, 302, 302′, 303. This check consists in verifying that there is no voltage downstream of the open relays.

Thus, during a step 403, a first voltage measurement downstream of the relays 301, 302, 302′, 303 is obtained. During a step 404, the balancing device 200 determines whether the voltage measured is zero. If the voltage measured is zero (response “yes” at the end of the step 404), then, during a step 405, the balancing device 200 obtains, at the end of a predetermined period T, a second measurement of the voltage downstream of the relays 301, 302, 302′, 303.

This new measurement (i.e. second measurement) of the voltage downstream of the relays 301, 302, 302′, 303 can be made at the period of the signal, i.e. 20 ms (electrical network of 50 Hz) or 16.7 ms (electrical network of 60 Hz) or at one second. According to a preferred embodiment, in order to minimise the electricity cutoff time, the measurement is made at the period of the signal, i.e. 20 ms (50 Hz signal) or 16.7 ms (60 Hz signal). Thus, according to a preferred embodiment, the predetermined period T is, for example, 20 ms or 16.7 ms.

During a step 406, the balancing device 200 determines whether the voltage measured is zero. If the voltage measured is zero (response “yes” at the end of the step 406), then the processing module UT 206 commands, during a step 407, the closure of the relay allowing connection of the output phase S, S1, S2 to the new input phase L1, L2, L3 of the electrical network.

On the other hand, if at the end of the step 404 the voltages measured downstream of the relays is different from 0 (i.e. non-zero voltage), then the balancing device 200 obtains, during a step 408, a new measurement (i.e. second measurement) at the end of the predetermined period T. If during a step 409 the balancing device 200 determines that the voltage measured is zero (response “yes” at the end of the step 409), then a new measurement (i.e. third measurement) is obtained by the balancing device 200 at the end of the predetermined period T in a step 410. Then, if during a step 411 the voltage measured is zero (response “yes” at the end of the step 411), then the processing module UT 206 commands the closure of the relay allowing connection of the output phase S, S1, S2 to the new input phase L1, L2, L3 of the electrical network (step 407).

On the other hand, if at the end of the steps 409 or 411 the voltage measured is different from 0 (response “no” at the end of the step 409 or response “no” at the end of the step 411), then the processing module UT 206 of the balancing device 200 commands, during a step 412, the closure of the relay allowing connection of the output phase S, S1, S2 to the current input phase L1, L2, L3, i.e. initially connected to the output phase S, S1, S2.

Thus, if a voltage is detected downstream of the relays 301, 302, 302', 303, the balancing device 200 re-closes the relay or relays that it has just opened. If two consecutive measurements are indeed at zero (over the three measurements made), the new relay or relays are closed, otherwise it is that there has been a command failure, and the balancing device 200 then re-closes the relays that were closed before reception of the phase connection change request.

According to one embodiment, the balancing device transmits to the information system SI an alert message comprising information representing a relay command failure.

It should be noted that, in the case of a 60 Hz electrical network, the total electricity cutoff time is between 43.34 ms and 70 ms. In fact, in general, the relay command time is 20 ms. The relay changes state (physical opening or closing) between 10 and 20 ms after reception of an opening and closing command signal. In the case where the polyphase electrical network is a 60 Hz electrical network with the voltage measured at the period of the signal, i.e. 16.7 ms, the first relay opens 10 ms after reception of the opening command signal, the first voltage measurement made after the end of the opening of the first relay is not zero. It is therefore necessary to await two additional measurements of the voltage at zero to command the closure of the second relay. In the worst case, the second relay closes 20 ms after reception of the closure command. The duration of cutoff of the electric current is therefore 3×16.67+20=70 ms.

In another example, the first relay opens 20 ms after reception of the opening command. The first voltage measurement made after the end of the opening of the first relay is therefore zero. It is therefore necessary to await a single additional measurement of the voltage at zero to command the closure of the second relay. In the best case, the second relay closes 10 ms after reception of the closure command. The duration of cutoff of the electric current is therefore 2×16.67+10=43.34 ms.

These times are very short and the majority of domestic or industrial equipment withstands this powerline disturbance without being impacted. An energy reserve could however be added at the entrance of the dwelling or business (e.g. behind the circuit breaker), in order to keep the loads supplied during the cutoff.

According to one embodiment, the balancing device 200 is incorporated in a single-phase or polyphase electricity meter.

According to another embodiment, the balancing device 200 is in the form of a remotely controllable relay box. In the electrical installation of the subscriber, this box is located between the polyphase electrical network and the single-phase or polyphase meter of the subscriber at the entrance to the home or business. This box is distinct from the electricity meter of the subscriber and comprises its own power supply.

This box can then be controlled directly by the information system SI of the electricity supplier or by the single-phase or polyphase meter of the subscriber.

The communication module COM 205 may be of the wired or wireless type. This communication module COM 205 may be PLC, radio frequency, cellular, wMBus, RS485 (with protocol such as ModBus for example), MBus, P1 input port, TIC input port, etc.

As described previously, at the time of change of connection to a new input phase, the box cuts off the load and therefore also the single-phase or polyphase electricity meter for at least 100 ms. This cutoff is not a problem for the electricity meter, which withstands cutoffs of up to 500 ms. The electricity meter will therefore not be cut off, even if the load is.

According to a particular embodiment, as described previously, the electricity meter of the electrical installation of this subscriber can measure the voltage of each of the phases of the polyphase electrical network. Thus, if it detects a voltage cutoff on the input phase of the electrical network to which the connection point of the electrical installation of the subscriber is connected, it can autonomously (i.e. without transferring the information to the information system SI) transmit a request for change of phase connection to the balancing device 200 to switch the connection to another input phase of the polyphase electrical network with voltage. As soon as it detects return of voltage on the input phase to which the connection point was previously connected, the meter reconnects this input phase via the balancing device 200.

1. A method for balancing loads in an electrical network comprising a plurality of phases, each phase supplying electrical energy to at least one connection point adapted to connect an electrical installation of a subscriber to said electrical network, wherein said method is implemented in a balancing device connected to said plurality of phases, said balancing device comprising a plurality of electromechanical relays, each electromechanical relay being adapted to connect a phase in said plurality of phases to an output phase (S) of said connection point, said output phase being intended to supply electrical energy to the electrical installation of the subscriber, and wherein said method comprises:
after reception, via a communication module, a request to change phase connection, commanding a step of phase connection change to switch from a connection, via a first electromechanical relay, to a first phase to which said output phase is initially connected, to a connection, via a second electromechanical relay, of said output phase to a second phase of said electrical network; said phase connection change step comprises:
commanding opening of all the electromechanical relays of said balancing device,
obtaining a first measurement of a voltage downstream of the electromechanical relays, and then, after a predetermined period (T), obtaining a second measurement of a voltage downstream of the electromechanical relays,
obtaining a third measurement of a voltage downstream of the electromechanical relays at the end of the predetermined period, when said first measurement is different from 0 and said second measurement is equal to 0,
commanding closure of said second electromechanical relay if:
(i) said first measurement is equal to 0 and said second measurement is equal to 0, or
(ii) said first measurement is different from 0, said second measurement is equal to 0, and said third measurement is equal to 0;
commanding closure of said first electromechanical relay if:
(i) said first measurement is different from 0 and said second measurement is different from 0, or
(ii) said first measurement is different from 0, said second measurement is different from 0, and said third measurement is different from 0.

2. The method according to claim 1, wherein said predetermined period is 20 ms when said electrical network has a frequency of 50 Hz or 16.7 ms when said electrical network has a frequency of 60 Hz or one second, preferentially 20 ms when said electrical network has a frequency of 50 Hz or 16.7 when said electrical network has a frequency of 60 Hz.

3. The method according to claim 1, wherein the commanding closure of said first electromechanical relay furthermore comprises: transmitting an alert message to an information system of an electricity supplier.

4. A balancing device for balancing loads in an electrical network comprising a plurality of phases, each phase supplying electrical energy to at least one connection point adapted to connect an electrical installation of a subscriber to said electrical network, wherein said balancing device is connected to said plurality of phases, said balancing device comprising:
a plurality of electromechanical relays, each electromechanical relay being adapted to connect a phase in said plurality of phases to an output phase of said connection point, said output phase being intended to supply electrical energy to the electrical installation of the subscriber, and
electronic circuitry configured to: after reception, via a communication module, a request to change phase connection, command a step of phase connection change to switch from a connection, via a first electromechanical relay, to a first phase to which said output phase is initially connected, to a connection, via a second electromechanical relay, of said output phase to a second phase of said electrical network, said phase connection change step comprises:
commanding opening of all the electromechanical relays of said balancing device),
obtaining a first measurement of a voltage downstream of the electromechanical relays, and then, after a predetermined period, obtaining a second measurement of a voltage downstream of the electromechanical relays,
obtaining a third measurement of a voltage downstream of the electromechanical relays at the end of the predetermined period, when said first measurement is different from 0 and said second measurement is equal to 0,
commanding closure of said second electromechanical relay if:
(i) said first measurement is equal to 0 and said second measurement is equal to 0, or
(ii) said first measurement is different from 0, said second measurement is equal to 0, and said third measurement is equal to 0;
commanding closure of said first electromechanical relay if:
(i) said first measurement is different from 0 and said second measurement is different from 0, or
(ii) said first measurement is different from 0, said second measurement is different from 0, and said third measurement is different from 0.

5. An electricity meter comprising the balancing device according to claim 4.

6. (canceled)

7. A non-transitory storage medium, storing a computer program product comprising instructions causing the execution, by a processor, of the method according to claim 1, when said instructions are read from the storage medium and executed by the processor.
